(19) United States
(12) Patent Application Publication
(10) Pub. No.: US 2019/0111563 A1
(43) Pub. Date: Apr. 18, 2019

(54) Custom Motion Trajectories for Robot Animation

(71) Applicant: Anki, Inc., San Francisco, CA (US)

(72) Inventors: Andrew Stein, San Francisco, CA (US); Kevin Yoon, Oakland, CA (US); Richard Allison Chaussee, San Francisco, CA (US); Bradford Neuman, San Francisco, CA (US); Kevin M. Karol, San Francisco, CA (US)

(21) Appl. No.: 16/035,463

(22) Filed: Jul. 13, 2018

Related U.S. Application Data
(60) Provisional application No. 62/573,095, filed on Oct. 16, 2017.

(51) Int. Cl. B25J 9/16; B25J 11/00; B25J 19/02

(52) U.S. Cl. CPC B25J 9/1664; B25J 11/003; B25J 19/023; B25J 11/001

(57) ABSTRACT

Systems for generating custom motion trajectories for robot animation are disclosed. One system includes a robot configured to maintain a current emotion state for the robot and a mapping between emotion state values and respective sets of custom motion parameters, in which the custom motion parameters control how procedural animations are performed by the robot, to receive one or more animation parameters of a procedural animation to be performed by the robot, to obtain a value of the current emotion state for the robot, to obtain one or more custom motion parameters to which the current emotion state is mapped, to compute a custom motion trajectory from the one or more animation parameters of the procedural animation and the obtained one or more custom motion parameters to which the current emotion state for the robot is mapped; and to perform the procedural animation according to the computed custom motion trajectory.

### CROSS-REFERENCE TO RELATED APPLICATIONS

This application claims the benefit under 35 U.S.C. § 119(e) of the filing date of U.S. Provisional Patent Application No. 62/573,095, filed on Oct. 16, 2017, entitled “Custom Motion Trajectories for Robot Animation,” the entirety of which is herein incorporated by reference.

### BACKGROUND

This specification relates to robots, and more particularly to robots used for consumer purposes.

A robot is a physical machine that is configured to perform physical actions autonomously or semi-autonomously. Robots have one or more integrated control subsystems that effectuate the physical movement of one or more robotic components in response to particular inputs. Robots can also have one or more integrated sensors that allow the robot to detect particular characteristics of the robot's environment.

Modern day robots are typically electronically controlled by dedicated electronic circuitry, programmable special-purpose or general-purpose processors, or some combination of these. Robots can also have integrated networking hardware that allows the robot to communicate over one or more communications networks, e.g., over Bluetooth, NFC, or WiFi.

Some robots can perform human-designed animations. In this specification, an animation performed by a physical robot includes a group of one or more coordinated movements by physical components of a robot. An animation can thus also refer to data that encodes such movements and encodes the coordination of the components with each other, which data will also be referred to simply as an animation when the meaning is clear from context. In some instances, an animation alternatively or in addition also specifies how to control other robot components that do not result in physical movement, e.g., electronic displays, lights, and sounds, to name just a few examples.

Human animators can manually design robot animations by using software that generates data encoding the animation movements. This process of creating pregenerated animations is generally laborious and time-intensive. In some implementations, such animation movements are encoded as keyframes. Each keyframe can for example encode a timestamp, starting point, an ending point, and a duration for a particular movement of a particular component. For example, a robot can effectuate a head tilt from angle A to angle B lasting 1 second by executing a keyframe that specifies these three items of data. Suitable techniques for generating animation keyframes for execution by a robot are described in commonly-owned U.S. patent application Ser. No. 15/633,382, filed Jun. 26, 2017, and entitled “Animation Pipeline for Physical Robot,” which is herein incorporated by reference.

Keyframes can be sequenced into tracks, with each track corresponding to a different component of the robot. The robot can then execute a track for a component by using the keyframes of the track to generate control signals for the corresponding component that effectuate the animation for that component. An animation can have one or more tracks, which can be layered together so that the robot can execute actions using multiple components simultaneously. Suitable techniques for layering tracks of an animation are described in commonly-owned U.S. patent application Ser. No. 15/633,652, filed Jun. 26, 2017, and entitled “Robot Animation Layering,” which is herein incorporated by reference.

In order to execute an animation track, a robot converts the information encoded into the keyframes into a trajectory for the corresponding component. A trajectory is thus data representing how a component moves over time. A trajectory can encode data about a position, e.g., an angle, at which a component should be over time, or a rate of change, e.g., a speed of a wheel turning, at which a component should operate over time. For example, from the example keyframe above, a robot can compute a trajectory that represents that within the keyframe duration, the robot head should be moving between angle A and angle B at a rate given by the difference between A and B divided by the duration. The trajectory information can be represented in any appropriate format, e.g., by a function that maps each of one or more time slices to a rate or a position for a particular component.

Pregenerated animations are rich in detail and can provide a robot with a life-like appearance. However, as described above, the process for creating such animations is laborious and time intensive. In addition, not all circumstances are predictable enough for a corresponding animation to be pregenerated in advance. Thus, in addition to pregenerated, keyframe-defined animations, robots can also execute procedural animations. Procedural animations are algorithmically generated based on current robot subsystem inputs. Typically, procedural animations cannot be pregenerated because they depend on a current state of the robot, a current state of the robot's environment, or both. For example, a robot can generate a procedural animation that causes the robot to navigate around an obstacle. The procedural animation cannot be pregenerated because the location of the obstacle is unknown until runtime.

Although run-time generated procedural animations allow the robot to respond to unforeseen circumstances, they often appear to conflict with pregenerated animations. For example, a human-designed animation that makes a robot appear to be sad, e.g., by hanging its head and turning slowly in a circle, can conflict with a subsequent procedural animation that causes the robot to drive quickly. Pregenerated and procedural animations can also be performed simultaneously by different components of the robot, e.g., a sad pregenerated eye animation and a happy procedural wheel trajectory. In either circumstance, these conflicts can give the robot a distracting, disconnected, and jerky user experience.

However, some degree of procedural animations are always necessary because human animator time is a bottleneck in robot development. In other words, it is very time consuming for human animators to design pregenerated animations. Even worse, the problem is simply intractable. That is to say, human animators cannot feasibly design a pregenerated animation for every possible scenario and every conceivable combination of subsystem inputs, even given massive resources and time to do so.

### SUMMARY

This specification describes technologies for generating custom motion trajectories for a mobile robot. A trajectory is data that a robot can execute to control the speed, acceleration, or timing, or some combination of these, of one or more robot components. A trajectory can thus be represented by one or more keyframes or another suitable data representation. For simplicity of presentation, the custom trajectories described in this specification will be referred to as custom motion trajectories generated using custom motion parameters, even though the robot components that can be controlled include both physically moveable components, e.g., wheels and arms, as well as non-physically moveable components that nevertheless have a notion of speed, acceleration, or timing, or some combination of these. For example, as will be discussed in more detail below, a custom motion trajectory can specify how quickly simulated eyes of a robot move across an electronic display. Although the eyes are not physically moveable components, the eyes can still be controlled by a custom motion trajectory that controls, for the eye movements, the speed, acceleration, timing, or some combination of these. The audio output of the robot is another example of a non-physically moveable component that can nevertheless also be modified by a custom motion trajectory. For example, the duration or start and stop times of the robot's audio output can be shifted or procedurally generated based on custom motion parameters.

In general, one innovative aspect of the subject matter described in this specification can be embodied in systems that include a robot comprising: a body and one or more physically moveable components; one or more processors; and one or more storage devices storing instructions that are operable, when executed by the one or more processors, to cause the robot to perform operations comprising: maintaining a current emotion state for the robot, in which the current emotion state is one value of a plurality of different emotion states, and in which the robot is configured to select pregenerated animations based on a value of the current emotion state for the robot; maintaining a mapping between emotion state values and respective sets of custom motion parameters, in which the custom motion parameters control how procedural animations are performed by the robot; receiving one or more animation parameters of a procedural animation to be performed by the robot; obtaining a value of the current emotion state for the robot; obtaining one or more custom motion parameters to which the current emotion state for the robot is mapped; computing a custom motion trajectory from the one or more animation parameters of the procedural animation and the obtained one or more custom motion parameters to which the current emotion state for the robot is mapped; and performing the procedural animation according to the computed custom motion trajectory. Other embodiments of this aspect include corresponding methods, apparatus, and computer programs recorded on one or more computer storage devices.

The foregoing and other embodiments can each optionally include one or more of the following features, alone or in combination. In particular, one embodiment includes all the following features in combination. The operations include: selecting, by the robot, a particular pregenerated animation based on a value for the current emotion state of the robot, in which the one or more custom motion parameters to which the current motion state for the robot is mapped match one or more characteristics of the particular pregenerated animation selected for the current emotion state of the robot. The one or more custom motion parameters include a maximum allowable speed, and computing the custom motion includes computing a custom motion trajectory that does not exceed the maximum allowable speed. The one or more custom motion parameters include an acceleration parameter, and computing the custom motion trajectory includes computing a custom motion trajectory having an acceleration characteristic based on the acceleration parameter. The one or more custom motion parameters include a deceleration parameter, and computing the custom motion trajectory includes computing a custom motion trajectory having a deceleration characteristic based on the deceleration parameter. The one or more custom motion parameters include a turn speed parameter, and computing the custom motion trajectory includes computing a custom motion trajectory having a turn speed characteristic based on the turn speed parameter. The one or more custom motion parameters include a turn acceleration parameter, and computing the custom motion trajectory includes computing a custom motion trajectory having a turn acceleration characteristic based on the turn acceleration parameter. The one or more custom motion parameters include a turn deceleration parameter, and computing the custom motion trajectory includes computing a custom motion trajectory having a turn deceleration characteristic based on the turn deceleration parameter. The one or more custom motion parameters are task-specific parameters, and computing the custom motion trajectory includes computing the custom motion trajectory having one or more movement characteristics based on the task-specific parameters. The one or more custom motion parameters include a duration parameter, and computing the custom motion trajectory includes computing the custom motion trajectory to have a duration matching the duration parameter. The one or more animation parameters of the procedural animation define a start point and an end point of a path to be traversed. The one or more animation parameters of the procedural animation define a path to be traversed. The one or more animation parameters of the procedural animation define the characteristics of a pose that the robot should assume. The one or more animation parameters of the procedural animation define a direction toward which the robot should turn and face or characteristics of an object or a user toward which the robot should turn and face. The one or more animation parameters of the procedural animation define an angle by which the robot should raise one of the physically movable components of the robot.

The subject matter described in this specification can be implemented in particular embodiments so as to realize one or more of the following advantages. Using custom motion parameters allows a robot to perform a customized run-time generation of procedural and pregenerated motion trajectories based on the robot's emotional state and environmental circumstances, e.g., the presence of an obstacle, that are not known ahead of time. This allows the robot to perform customized animations that could not have been generated by a human animator, which makes the robot seem more lifelike and makes the robot's behavior more consistent and understandable, particularly when responding to new or unpredictable circumstances. The ability to maintain consistency in robot behavior between pregenerated animations and procedural motions also makes the robot to appear more life-like and natural. Custom motion parameters can also allow a robot to be programmed more declaratively and less imperatively, removing the need for developers to think about how a robot will perform certain actions. With custom motion parameters, it becomes possible to program only what the robot should do, separately from how. This allows developers to work more quickly without concern for how particular motions are performed. Therefore, what the robot does and how the robot does it can actually be addressed by separate developers or even separate departments in a way that wouldn't otherwise be possible.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example robot.

FIG. 2 illustrates the architecture of an example motion subsystem.

FIG. 3 is a flowchart of an example process for computing a custom motion trajectory for a robot.

Like reference numbers and designations in the various drawings indicate like elements.

### DETAILED DESCRIPTION

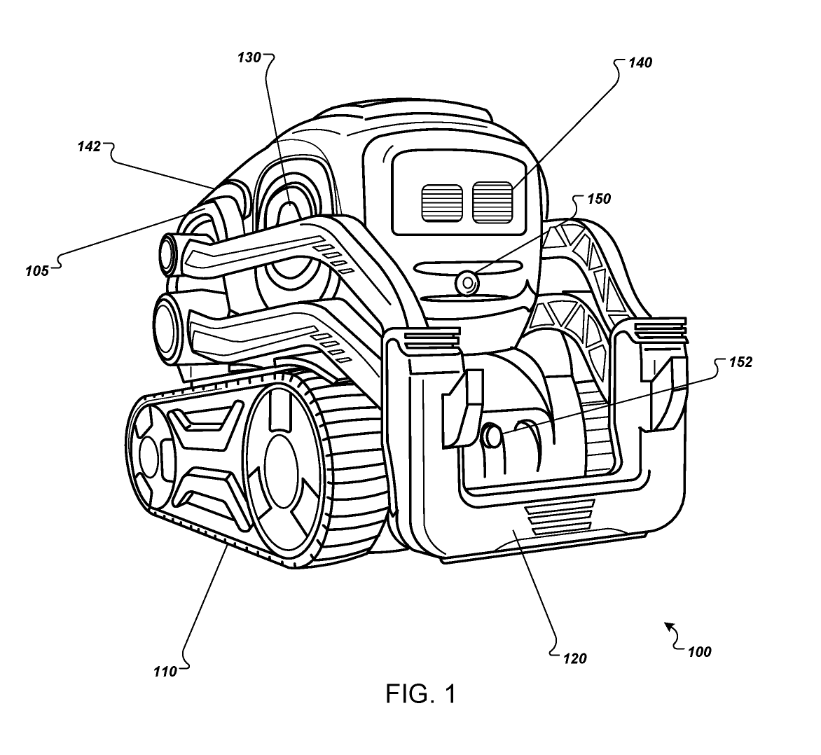

FIG. 1 illustrates an example robot 100. The robot 100 is an example of a mobile autonomous robotic system on which the custom motion trajectory generation techniques described in this specification can be implemented. The robot 100 can use the techniques described below for use as a toy or as a personal companion.

The robot 100 generally includes a body 105 and a number of physically moveable components. The components of the robot 100 can house data processing hardware and control hardware of the robot. The physically moveable components of the robot 100 include a propulsion system 110, a lift 120, and a head 130.

The robot 100 also includes integrated output and input subsystems.

The output subsystems can include control subsystems that cause physical movements of robotic components; presentation subsystems that present visual or audio information, e.g., screen displays, lights, and speakers; and communication subsystems that communicate information across one or more communications networks, to name just a few examples.

The control subsystems of the robot 100 include a locomotion subsystem 110. In this example, the locomotion system 110 has wheels and treads. Each wheel subsystem can be independently operated, which allows the robot to spin and perform smooth arcing maneuvers. In some implementations, the locomotion subsystem includes sensors that provide feedback representing how quickly one or more of the wheels are turning. The robot can use this information to control its position and speed.

The control subsystems of the robot 100 include an effector subsystem 120 that is operable to manipulate objects in the robot's environment. In this example, the effector subsystem 120 includes a lift and one or more motors for controlling the lift. The effector subsystem 120 can be used to lift and manipulate objects in the robot's environment. The effector subsystem 120 can also be used as an input subsystem, which is described in more detail below.

The control subsystems of the robot 100 also include a robot head 130, which has the ability to tilt up and down and optionally side to side. On the robot 100, the tilt of the head 130 also directly affects the angle of a camera 150.

The presentation subsystems of the robot 100 include one or more electronic displays, e.g., electronic display 140, which can each be a color or a monochrome display. The electronic display 140 can be used to display any appropriate information. In FIG. 1, the electronic display 140 is presenting a simulated pair of eyes. The presentation subsystems of the robot 100 also include one or more lights 142 that can each turn on and off, optionally in multiple different colors.

The presentation subsystems of the robot 100 can also include one or more speakers, which can play one or more sounds in sequence or concurrently so that the sounds are at least partially overlapping.

The input subsystems of the robot 100 include one or more perception subsystems, one or more audio subsystems, one or more touch detection subsystems, one or more motion detection subsystems, one or more effector input subsystems, and one or more accessory input subsystems, to name just a few examples.

The perception subsystems of the robot 100 are configured to sense light from an environment of the robot. The perception subsystems can include a visible spectrum camera, an infrared camera, or a distance sensor, to name just a few examples. For example, the robot 100 includes an integrated camera 150. The perception subsystems of the robot 100 can include one or more distance sensors. Each distance sensor generates an estimated distance to the nearest object in front of the sensor.

The perception subsystems of the robot 100 can include one or more light sensors. The light sensors are simpler electronically than cameras and generate a signal when a sufficient amount of light is detected. In some implementations, light sensors can be combined with light sources to implement integrated cliff detectors on the bottom of the robot. When light generated by a light source is no longer reflected back into the light sensor, the robot 100 can interpret this state as being over the edge of a table or another surface.

The audio subsystems of the robot 100 are configured to capture from the environment of the robot. For example, the robot 100 can include a directional microphone subsystem having one or more microphones. The directional microphone subsystem also includes post-processing functionality that generates a direction, a direction probability distribution, location, or location probability distribution in a particular coordinate system in response to receiving a sound. Each generated direction represents a most likely direction from which the sound originated. The directional microphone subsystem can use various conventional beam-forming algorithms to generate the directions.

The touch detection subsystems of the robot 100 are configured to determine when the robot is being touched or touched in particular ways. The touch detection subsystems can include touch sensors, and each touch sensor can indicate when the robot is being touched by a user, e.g., by measuring changes in capacitance. The robot can include touch sensors on dedicated portions of the robot's body, e.g., on the top, on the bottom, or both. Multiple touch sensors can also be configured to detect different touch gestures or modes, e.g., a stroke, tap, rotation, or grasp.

The motion detection subsystems of the robot 100 are configured to measure movement of the robot. The motion detection subsystems can include motion sensors and each motion sensor can indicate that the robot is moving in a particular way. For example, a gyroscope sensor can indicate a relative orientation of the robot. As another example, an accelerometer can indicate a direction and a magnitude of an acceleration, e.g., of the Earth's gravitational field.

The effector input subsystems of the robot 100 are configured to determine when a user is physically manipulating components of the robot 100. For example, a user can physically manipulate the lift of the effector subsystem 120, which can result in an effector input subsystem generating an input signal for the robot 100. As another example, the effector subsystem 120 can detect whether or not the lift is currently supporting the weight of any objects. The result of such a determination can also result in an input signal for the robot 100.

The robot 100 can also use inputs received from one or more integrated input subsystems. The integrated input subsystems can indicate discrete user actions with the robot 100. For example, the integrated input subsystems can indicate when the robot is being charged, when the robot has been docked in a docking station, and when a user has pushed buttons on the robot, to name just a few examples.

The robot 100 can also use inputs received from one or more accessory input subsystems that are configured to communicate with the robot 100. For example, the robot 100 can interact with one or more cubes that are configured with electronics that allow the cubes to communicate with the robot 100 wirelessly. Such accessories that are configured to communicate with the robot can have embedded sensors whose outputs can be communicated to the robot 100 either directly or over a network connection. For example, a cube can be configured with a motion sensor and can communicate an indication that a user is shaking the cube.

The robot 100 can also use inputs received from one or more environmental sensors that each indicate a particular property of the environment of the robot. Example environmental sensors include temperature sensors and humidity sensors to name just a few examples.

One or more of the input subsystems described above may also be referred to as “sensor subsystems.” The sensor subsystems allow a robot to determine when a user is interacting with the robot, e.g., for the purposes of providing user input, using a representation of the environment rather than through explicit electronic commands, e.g., commands generated and sent to the robot by a smartphone application. The representations generated by the sensor subsystems may be referred to as “sensor inputs.”

The robot 100 also includes computing subsystems having data processing hardware, computer-readable media, and networking hardware. Each of these components can serve to provide the functionality of a portion or all of the input and output subsystems described above or as additional input and output subsystems of the robot 100, as the situation or application requires. For example, one or more integrated data processing apparatus can execute computer program instructions stored on computer-readable media in order to provide some of the functionality described above.

The robot 100 can also be configured to communicate with a cloud-based computing system having one or more computers in one or more locations. The cloud-based computing system can provide online support services for the robot. For example, the robot can offload portions of some of the operations described in this specification to the cloud-based system, e.g., for determining behaviors, computing signals, and performing natural language processing of audio streams.

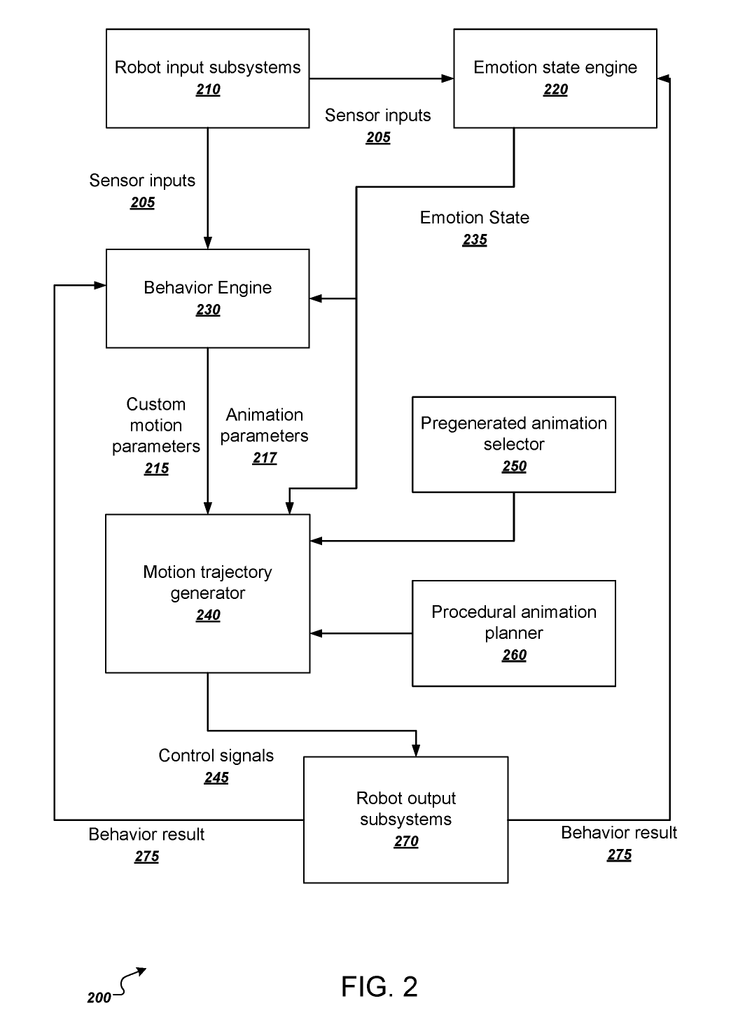

FIG. 2 illustrates the architecture of an example motion subsystem 200 of a robot. In general, the system 200 controls how the robot performs pregenerated animations and procedural animations, which can each be based on or influenced by custom motion parameters. The behavior engine 230 can compute the custom motion parameters 215 based on the robot's emotion state 235, sensor inputs 205, the behavior result 275 from the robot's last preceding action, or some combination of these. A motion trajectory generator 240 can determine one or more custom motion trajectories that the robot's various components should perform based on the custom motion parameters 215, and optionally the emotion state 235. To do so, the motion trajectory generator 240 can use inputs from a procedural animation planner 260, a pregenerated animation selector 250, or both. The motion trajectory generator 240 can then send control signals 245 to the robot's output subsystems 270 to drive components corresponding to the custom motion trajectories generated by the robot. Designing the emotion state engine 220 of the robot to influence both pregenerated and procedural behavior allows the robot's behavior to appear more naturally consistent with its general simulated emotion state.

The robot input subsystems 210 provide sensor inputs 205. Sensor inputs 205 include information such as obstacles observed by the robot or recognition of a user's face. The robot can obtain the sensor inputs using any appropriate combination of sensor subsystems described above. Each sensor subsystem generates a representation of the robot's environment that is particular to that sensor. For example, a camera can generate a color image of the environment, while a cliff sensor can generate an indication of whether or not surface-reflected light is detected.

The emotion state engine 220 generates an emotion state 235 in order to simulate emotional characteristics of the robot's behavior. For example, the emotion state engine 220 can generate an emotion state 235 that influences the pregenerated and procedural animations performed by the robot, which allows the robot to simulate emotions including happy, sad, angry, and cautious, to name just a few examples. Using the emotion state 235 in this way can enhance user engagement with the robot and can improve the interface between users and the robot by making the robot's actions and responses readily understandable.

The emotion state 235 for a robot can be a single-dimensional or a multi-dimensional data structure, e.g., a vector or an array, that maintains respective values for each of one or more different aspects. Each aspect can represent an enumerated value or a particular value on a simulated emotional spectrum, with each value for each aspect representing a location within that simulated emotional spectrum. For example, an example emotion state can have the following values: Happy, Calm, Brave, Confident, Excited, and Social, each of which may have a negative counterpart. Alternatively or additionally, machine learning can be used to model how custom motion parameters change given a complex multi-dimensional emotional state input or function.

The emotion states need not correspond to specifically identifiable human emotions. Rather, the emotion state can also represent other, more general or more specific spectrums that characterize robot behavior. For example, the emotion state can be a Social state that represents how eager the robot is to interact with users generally, a Want-To-Play state that represents how eager the robot is to engage in gameplay with a user, and a Winning state that represents how competitive the robot is in games. The emotion state can also correspond to a desired or impending change in external circumstances, such as changing the state of the user or an object, e.g., Want-to-Frighten or Want-to-Soothe. Emotion states can also correspond to current physical states of the robot, such as Needs-Repair and Hungry. Such states can manifest in the same sort of character and motion constraints as other emotion states. Sensor inputs 205 can also be used by the behavior engine 230 to generate custom motion parameters 215, animation parameters 217, or both. The animation parameters 217 can describe the action to be taken by a physically movable or non-physically movable component of the robot, such as the eyes, speakers, wheels, or head. Examples of the animation parameters 217 include the start and end points of a path to be traversed by the robot, the style, e.g., stiffness or smoothness, by which the procedural animation should be performed, the characteristics of a pose that the robot should assume, the path itself, the direction toward which the robot should turn and face or the characteristics of a user or an object toward which the robot should turn and face, and an angle by which the robot should raise one of its physically movable components, to name just a few examples.

In some embodiments, behavior engine 230 can generate custom motion parameters 215 by incorporating the behavior result 275 that represents the outcome of executing the animations of a particular prior behavior. For example, the robot can note its new relative location based on previous movements. This location can be used as a start point of a path to be traversed by the robot.

The custom motion parameters 215 can be any appropriate value that defines or modifies a property of a trajectory. The custom motion parameters 215 can include respective values for desired speed, a maximum or minimum allowable speed, desired acceleration or deceleration, a maximum or minimum acceleration or deceleration, a desired turn speed, a maximum or minimum turn speed, a desired turn acceleration or turn deceleration, a maximum or minimum turn acceleration or deceleration, a desired duration, and a maximum or a minimum duration, to name just a few examples. In some implementations, specific tasks are associated with specific sets of custom motion parameters. Thus, a particular task, e.g., lifting a cube, can be associated with a distinct set of custom motion parameters for any of the custom motion parameters described above. For general tasks or otherwise in the absence of task-specific custom motion parameters, the robot can use a global or default set of custom motion parameters.

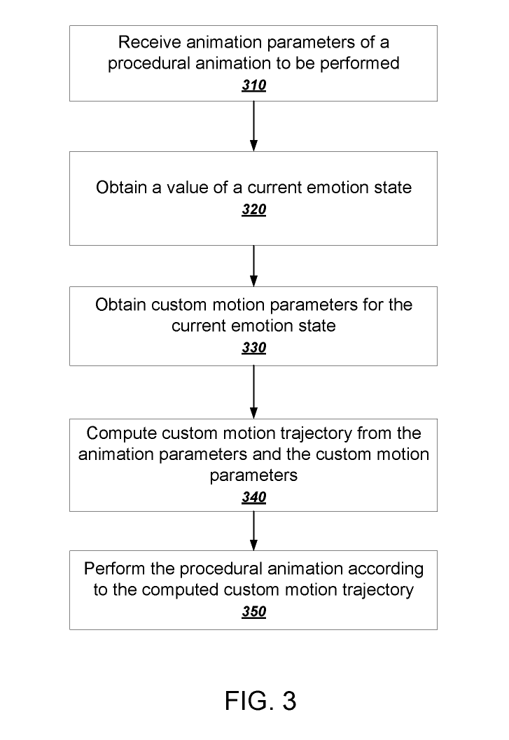

The behavior engine 230 can map each different emotion state 235 to a respective set of custom motion parameters 215. For example, the desired speed parameter may be slower based on a “sad” emotion state 235. Similarly, if the emotion state is a complex multi-dimensional emotional state input or function, the robot can map each discrete emotion state value in that function with a respective custom motion parameter. This can either be implemented as a direct mapping between each enumerated emotion state and corresponding custom motion parameters. Alternatively or in addition, the robot can define a function that maps an emotion state having one or more dimensions to respective custom motion parameters. In some implementations, the values of the custom motion parameters for a given emotion state are learned from a collection of pregenerated animations for the emotion state, which is described in more detail below with reference to FIG. 3.

Then, for any particular emotion state, behavior engine 230 can obtain the custom motion parameters 215 to which the emotion state 235 is mapped and motion trajectory generator 240 can use those custom motion parameters to calculate the trajectories of each procedurally generated animation. This process provides some customization over procedural animations, which cannot be pregenerated. This process also has the effect of smoothing out the transitions to or from pregenerated animations, which, like custom motion parameters, can also be selected according to emotion states.

The motion trajectory generator 240 can compute a custom motion trajectory from the custom motion parameters 215 using procedural animation planner 260, a pregenerated animation selector 250, the emotion state 235, or some combination of these. Based on custom motion parameters 215, motion trajectory generator 240 determines a procedural animation trajectory using procedural animation planner 260, and optionally selects a pregenerated animation from pregenerated animation library 250, to determine a final combined trajectory. As described above, the robot can generate procedural animations, using procedural animation planner 260, based on data that is unknown in advance, e.g., paths around obstacles. Another example of such data is user input. For example, the procedural animation can involve waiting for a user to speak a command after saying the user's name, which are both audio events whose durations are unknown in advance.

The motion trajectory generator 240 can generate the custom motion trajectory in any appropriate format, which can include being generated as keyframes, control signal representations, or some other intermediate representation of trajectories themselves or data from which appropriate trajectories can be computed.

The robot can directly compute the custom motion trajectories based on the custom motion parameters, or the robot can use the custom motion parameters to modify the original trajectories of an original procedural animation.

To compute custom motion trajectories based on the custom motion parameters, the motion trajectory generator 240 can compute procedural animation trajectories having properties that match the computed custom motion parameters. The term “match,” in this context, can mean defined by or limited by. For example, a custom motion parameter that is a desired speed can define the speed in a custom motion trajectory, while a custom motion parameter that is a maximum speed can serve to limit the speed in any generated custom motion trajectory.

For example, the motion trajectory generator 240 can receive custom motion parameters 215 and animation parameters 217 from the behavior engine 230. The animation parameters 217 can define a path around an obstacle. In order to cause the robot to navigate the specified path, the motion trajectory generator 240 needs to work with procedural animation planner 260 to generate procedural trajectories for each of the required components. To cause the robot to follow a path, the procedural animation planner 260 can generate separate trajectories for each of the wheels that, when effectuated by the wheels, cause the robot to navigate along the path. The motion trajectory generator 240 can combine the separate trajectories into a final control signals 245 to be executed by the robot output subsystems 270.

When generating each wheel trajectory that defines how a particular wheel is rotated, accelerated, and for how long, the robot can consider whether any custom motion parameters will affect the trajectory. For example, the custom motion parameters can specify a desired speed or a desired acceleration. This can be useful, for example, if the robot's emotion state is sad, and zippy speeds or accelerations would result in actions that do not match the robot's emotion state. In that case, instead of generating a wheel trajectory having a default value, e.g., a maximum speed or acceleration, the robot can generate a wheel trajectory that specifies a wheel speed or acceleration matching the desired wheel speed or acceleration of the custom motion parameters. Alternatively or in addition, if the custom motion parameters specify a maximum wheel speed, the robot is free to generate a wheel trajectory having any speeds that are less than the maximum wheel speed.

Alternatively or in addition, the robot can compute custom motion trajectories by modifying original trajectories. For example, an original procedural motion trajectory can define a wheel trajectory that specifies moving a wheel at speed X for 2 seconds and then decelerating at rate a until the wheel stops moving. In the absence of any explicit acceleration parameters, the robot can accelerate as fast as possible to get the wheel trajectory up to speed X. This example trajectory can thus direct the robot to accelerate as quickly as the robot can in order to get up to speed X, followed by a smooth deceleration and stop.

Note that the initial burst of speed can seem incongruous with emotions states that are associated with sluggishness, e.g., sadness, loneliness, or tiredness, to name just a few examples. Therefore, the custom motion parameters for any of these emotion states can be defined to limit such incongruous actions. In this example, two custom motion parameters can be maximum allowable speed and maximum acceleration rate. Therefore, an emotion state corresponding to sad can be associated with custom motion parameter values that limit the maximum speed and acceleration rate. Then, if the robot's emotion state is sad, the robot can generate a custom motion trajectory by modifying the original procedural motion trajectory according to any applicable custom motion parameters for the sad emotion state. In this example, the robot can determine that the wheel trajectory at speed X of the original procedural motion trajectory exceeds the value for the maximum speed custom motion parameter for the sad emotion state. In response, the robot can modify the original procedural motion trajectory to reduce the speed X to a speed Y that is equal to or lower than the value of the maximum speed of the custom motion parameters. Similarly, the robot can determine that the default maximum acceleration of the original procedural motion trajectory exceeds the value for the maximum acceleration rate of the custom motion parameters for the sad emotion state. In response, the robot can further modify the original procedural motion trajectory to define a slower rate of initial acceleration that is equal to or lower than the value of the maximum acceleration custom motion parameter.

The robot can then execute the custom motion trajectory. When pregenerated animations for the emotion state are performed adjacent to the procedural animation defined by the custom motion trajectory, the transitions will be much smoother and the overall character effect of the robot will be more convincing and lifelike. Notably, the procedural animation, which could not have been pregenerated by a human animator, nevertheless matches the characteristics of the other pregenerated animations.

In another example, the custom motion parameters 215 can specify that the robot's head should move from angle θ₁ to angle θ₂. In the absence of any custom motion parameters defining or limiting head angle acceleration, the robot might generate and execute the original procedural motion trajectory by accelerating the head as fast as possible to up to a speed required to move the head from the start angle to the end angle within the given duration.

However, this kind of unbounded acceleration can be undesirable for a number of reasons and can thus be controlled by custom motion parameters. For example, the robot can consider a maximum head acceleration custom motion parameter when generating the procedural motion trajectory for a particular emotion state. Alternatively or in addition, the robot can modify an original procedural motion trajectory to reduce the acceleration of the head to be equal to or lower than the value of the maximum head acceleration of the custom motion parameters. The robot can then execute the custom motion trajectory.

The motion trajectory generator 240 can also use the emotion state 235 to modify other attributes of a procedural animation that are not direct trajectory properties. For example, the custom motion parameters 215 can define a path between two points. The motion trajectory generator 240 can modify the path to correspond to the robot's emotion state. For example, if the robot is “clumsy” as an emotion state, the motion trajectory generator 240 can generate trajectories that modify the robot's path so that the path is more meandering in order to enforce the appearance of “clumsiness.” For example, if the robot's wheel is actually broken or simulated to be broken so that the robot can only turn in one direction, the motion trajectory generator 240 can generate trajectories defining a path in which the robot must turn 270 degrees counterclockwise to turn 90 degrees clockwise.

The motion trajectory generator 240 can also modify the robot's capability to successfully dock with an object, such as cube, depending on the robot's emotion state. If the robot's emotion state is “clumsy,” the motion trajectory generator 240 can generate trajectories that cause the robot to perform several docking attempts with the cube before succeeding.

In some implementations, the motion trajectory generator 240 alternatively or in addition uses the pregenerated animation library 250, and emotion state 235, to select a pregenerated animation for the robot to perform as part of its final trajectory. For example, if the robot's emotion state is happy, a “happy dance” pregenerated animation can be selected. The motion trajectory generator 240 optionally matches one or more of the custom motion parameters to one or more of animation characteristics of a selected pregenerated animation. For example, if the robot is programmed to perform a happy dance pregenerated animation at a certain speed, the motion trajectory generator 240 can modify the speed of the trajectory specified by the procedural motion trajectory that precedes or follows the happy dance to match the speed of the happy dance. Such matching between procedural and pregenerated animations allows the robot's behavior to appear even more naturally consistent with its emotional state.

Motion trajectory generator 240 can also mix pregenerated animation tracks with procedurally generated animation tracks. By using custom motion parameters, the procedurally generated tracks can match the characteristics of the pregenerated tracks. For example, the robot can use the custom motion parameters for a particular emotion state to generate trajectories for the wheels that correspond to the emotion state. However, the robot can select pregenerated animation tracks for other robot components that do not conflict with the operation of the wheels. For example, the lift and eyes of the robot can be controlled by pregenerated animation tracks selected based on the emotion state. Thus, in this example, the custom motion parameters allow the robot to compute procedural animation tracks for the wheels that match the characteristics of the pregenerated animation tracks for the lift and eyes.

The motion trajectory generator 240 can use the custom motion trajectory, optionally with the animation characteristics, to generate one or more corresponding control signals 245 that drive the components of the robot through the robot output subsystems 270, causing the robot to perform the procedural animation corresponding to the custom motion trajectory.

The emotion state engine 220 can update the emotion state 235 in response to the behavior result 275 that represents the outcome of executing the animations of a particular behavior. In this specification, a “behavior” refers to a set of one or more coordinated animations, which can include pregenerated animations, procedural animations, or both, and optionally one or more responses. In this specification, “responses” can include system processing of an emotion state or a sensor input.

For example, if the robot is initially sad but performs a behavior that allows him to recognize a human, e.g., by turning and detecting the user's face, the behavior result can influence the robot's subsequent emotion state. This, in turn, can result in changes in the animations performed by the robot, e.g., happier animations. And the custom motion trajectories for the happier emotion state will also cause the procedural animations to match the happier pregenerated animations as well.

The emotion state engine 220 can also update the emotion state 235 in response to other occurrences or inputs. For example, the emotion state engine 220 can receive a command from another application or subsystem that directly sets one or more values of the emotion state. For example, game-related emotion aspects can be altered by a game application to have particular preset values when the robot is participating in a game. Other inputs that can impact the emotion state engine include: familiarity of the robot with the terrain of travel, presence of known faces, and time of day.

As another example, the robot can be configured to respond to the presence of unknown or unauthorized users or other signs of danger, which are all other inputs that can result in a change in the emotion state. For example, upon detecting an unexpected user, the robot can update the emotion state to a scared emotion state. This change in emotion state can affect the custom motion parameters that are generated for procedural animations. For example, the next procedural action that the robot selects can be to plan a path to drive toward the unknown user for a better view. The scared emotion state can be mapped to custom motion parameters that specify moving at maximum speeds and accelerations. Then, when the robot generates trajectories for traveling the path, the custom motion parameters can cause the trajectory to reflect the scared emotion state, resulting in the robot acting quickly to respond to the original input.

The custom motion parameters for a particular procedural animation can change over time, even while a particular animation is being performed. For example, the robot can be traversing a path according to custom motion parameters mapped to by an excited emotion state, which results in quick actions. But a sudden drop in battery power below a particular threshold can cause the emotion state to transition to a tired emotion state, which in turn maps to a different set of custom motion parameters that have the effect of reducing the maximum motor speeds while the procedural animation is performed. These new custom motion parameters can then be applied to the previously generated path such that the robot now traverses it more slowly. In addition, in some implementations, a parameter is actually a reference to function that can take into consideration other external data. For example, the robot can use one or more functions that specify how a path should be altered due to external parameters, e.g., time. For example, the robot can perform an animation in which it appears that a wheel has fallen asleep. A custom motion parameter can identify a function that whose output specifies that for the first 2 seconds of motion, the wheel has to gain speed more slowly, but after that time it has woken up, and therefore, thereafter the acceleration is not clipped after the 2 second mark.

The feedback loop of the emotion state 235, in which behaviors can influence the emotion state and the updated emotion state can influence behaviors, provide for complex and emergent behaviors that are not specifically pre-programmed or hard coded into the robot's software.

The emotion state 235 may also change over time on a per user basis. For example, the user may learn to more efficiently comfort the robot when it is expressing sad emotion state characteristics. The robot may then change its emotion state, e.g., to a happier state, faster with this user. This change to a happier emotion state would then be reflected in the custom motion trajectories and pregenerated animations exhibited by the robot.

FIG. 3 is a flowchart of an example process for computing a custom motion trajectory for a robot. The example process will be described as being performed by a robot programmed appropriately in accordance with this specification. For example, the robot 100 of FIG. 1, appropriately programmed, can perform the example process.

The robot receives custom motion parameters of a procedural animation to be performed (310). For example, the animation parameters can specify waypoints along a path to be traversed by the robot.

The robot obtains a value of a current emotional state (320). As described above, an emotion state engine can maintain a value of the emotion state of the robot, which can be one of a plurality of discrete emotions states. The emotion states can be used by the robot to select pregenerated animations to perform in particular scenarios.

The robot obtains custom motion parameters for the current emotion state (330). The system can define custom motion parameters for a variety of different actions and emotion states.

For example, the system can define respective global traversal parameters for each component that define maximum or minimum values for speed, acceleration, deceleration, or some combination of these, for the respective component. In some implementations, the system also defines one or more reverse traversal parameters that define minimums and maximums for traversing in reverse.

In some implementations, the system defines task-specific traversal parameters that apply only to particular tasks or behaviors. As one example, the system can define task-specific traversal parameters for the robot interacting with an object, e.g. a cube. The task-specific traversal parameters specify traversal parameters that apply only when the robot is performing a particular interaction with the object, e.g. docking with another object, as opposed to the global traversal parameters that apply otherwise. As another example, the system can define global or task-specific turning parameters that define maximum or minimum turning speed, acceleration, deceleration, or some combination of these.

The values of the custom motion parameters can be hand tuned, generated based on empirical data, e.g., using machine-learning techniques, or some combination of these. For example, for each particular value of an emotion state, the system can compile a collection of pregenerated animations for that emotion state. In some embodiments, pregenerated animations are tagged with emotion state values, sorting pregenerated animations by corresponding emotion state. The tags can be assigned by human animators or compiled form empirical data about the pregenerated animations that were performed for each emotion state. The system can then compute statistics about characteristic movements for the pregenerated animations of that emotion state and base the values of the custom motion parameters on those statistics.

As one example, the system can sample from a collection of pregenerated animations for the sad emotion state. From the collection of pregenerated animations, the system can generate corresponding motion trajectories and compute statistics on the accelerations and decelerations that are involved in the collection of pregenerated animations. The system can then set a custom motion parameter for maximum acceleration based on the accelerations observed in the sample set. In some implementations, the value is based on a particular percentile of the acceleration values observed in the sample set, e.g., the 50th, 80th, or 90th percentile. In this way, the system can automatically generate the custom motion parameters to match the characteristics of the pregenerated animations. Alternatively, or additionally, the system can use a regression analysis to fit the custom motion parameters to the characteristic movements for the pregenerated animations of that emotion state.

Alternatively or in addition, some values of the custom motion parameters can be generated on the fly at runtime to match pregenerated animations performed at or near the time of procedural motion trajectories. For example, instead of computing the custom motion parameter values offline from a collection of pregenerated animations, the robot can compute the custom motion parameter values online from one or more immediately preceding pregenerated animations, one or more pregenerated animations queued to play next, or some combination of these. For example, if the robot performs a pregenerated animation corresponding to the sad emotion state, the robot can compute the custom motion parameter values for a succeeding motion on the fly, e.g., from values of speeds, accelerations, and decelerations present in the trajectories of the pregenerated animation.

Runtime-computed custom motion parameters can also be blended or interpolated to smooth transitions between emotion states. For example, suppose that a particular behavior involves transitioning the robot from a sad emotion state to a happy emotion state. This behavior can require performing a first pregenerated animation corresponding to sad, then a procedural animation, then a second pregenerated animation corresponding to happy. In this scenario, the robot can interpolate the custom motion parameter values from the values for sad to the values for happy over time. This has the effect of changing the constraints of the custom motion parameters over the course of the procedural animation. For example, at the start of the procedural animation, the maximum speed can be based on a first maximum speed for the custom motion parameters for the sad emotion state, but by the end of the procedural animation, the maximum speed can be based on a second maximum speed for the custom motion parameters for the happy emotion state.

The robot computes a custom motion trajectory from the animation parameters and the custom motion parameters (340). As described above, the robot can compute the custom motion trajectory by modifying an original motion trajectory computed from the custom motion parameters.

If any characteristics of the original motion trajectory conflict with the custom motion parameters, the robot can alter the original motion trajectory to generate a custom motion trajectory that conforms to the custom motion parameters.

The robot performs the procedural animation according to the computed custom motion trajectory (350). After generating the custom motion trajectory, the robot can use the custom motion trajectory to control robot components at the trajectories specified by the custom motion trajectory.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For a robot to be configured to perform particular operations or actions means that the system has installed on it software, firmware, hardware, or a combination of them that in operation cause the robot to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a robot, a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A robot comprising:
a body and one or more physically moveable components;
one or more processors; and
one or more storage devices storing instructions that are operable, when executed by the one or more processors, to cause the robot to perform operations comprising:
maintaining a current emotion state for the robot, wherein the current emotion state is one value of a plurality of different emotion states, and wherein the robot is configured to select pregenerated animations based on a value of the current emotion state for the robot;
maintaining a mapping between emotion state values and respective sets of custom motion parameters, wherein the custom motion parameters control how procedural animations are performed by the robot;
receiving one or more animation parameters of a procedural animation to be performed by the robot;
obtaining a value of the current emotion state for the robot;
obtaining one or more custom motion parameters to which the current emotion state for the robot is mapped;
computing a custom motion trajectory from the one or more animation parameters of the procedural animation and the obtained one or more custom motion parameters to which the current emotion state for the robot is mapped; and
performing the procedural animation according to the computed custom motion trajectory.

2. The robot of claim 1, wherein the operations further comprise:
selecting, by the robot, a particular pregenerated animation based on a value for the current emotion state of the robot,
wherein the one or more custom motion parameters to which the current motion state for the robot is mapped match one or more characteristics of the particular pregenerated animation selected for the current emotion state of the robot.

3. The robot of claim 1, where the one or more custom motion parameters comprise a maximum allowable speed, and wherein computing the custom motion comprises computing a custom motion trajectory that does not exceed the maximum allowable speed.

4. The robot of claim 1, wherein the one or more custom motion parameters comprise an acceleration parameter, and wherein computing the custom motion trajectory comprises computing a custom motion trajectory having an acceleration characteristic based on the acceleration parameter.

5. The robot of claim 1, wherein the one or more custom motion parameters comprise an deceleration parameter, and wherein computing the custom motion trajectory comprises computing a custom motion trajectory having an deceleration characteristic based on the deceleration parameter.

6. The robot of claim 1, wherein the one or more custom motion parameters comprise an turn speed parameter, and wherein computing the custom motion trajectory comprises computing a custom motion trajectory having a turn speed characteristic based on the turn speed parameter.

7. The robot of claim 1, wherein the one or more custom motion parameters comprise an turn acceleration parameter, and wherein computing the custom motion trajectory comprises computing a custom motion trajectory having a turn acceleration characteristic based on the turn acceleration parameter.

8. The robot of claim 1, wherein the one or more custom motion parameters comprise an turn deceleration parameter, and wherein computing the custom motion trajectory comprises computing a custom motion trajectory having a turn deceleration characteristic based on the turn deceleration parameter.

9. The robot of claim 1, wherein the one or more custom motion parameters are task-specific parameters, and wherein computing the custom motion trajectory comprises computing the custom motion trajectory having one or more movement characteristics based on the task-specific parameters.

10. The robot of claim 1, wherein the one or more custom motion parameters comprise a duration parameter, and wherein computing the custom motion trajectory comprises computing the custom motion trajectory to have a duration matching the duration parameter.

11. The robot of claim 1, wherein the one or more animation parameters of the procedural animation define a start point and an end point of a path to be traversed.

12. The robot of claim 1, wherein the one or more animation parameters of the procedural animation define a path to be traversed.

13. The robot of claim 1, wherein the one or more animation parameters of the procedural animation define the characteristics of a pose that the robot should assume.

14. The robot of claim 1, wherein the one or more animation parameters of the procedural animation define a direction toward which the robot should turn and face or characteristics of an object or a user toward which the robot should turn and face.

15. The robot of claim 1, wherein the one or more animation parameters of the procedural animation define an angle by which the robot should raise one of the physically movable components of the robot.

16. A computer program product, encoded on one or more non-transitory computer storage media, comprising instructions that when executed by one or more processors of a robot cause the robot to perform operations comprising:
maintaining a current emotion state for the robot, wherein the current emotion state is one value of a plurality of different emotion states, and wherein the robot is configured to select pregenerated animations based on a value of the current emotion state for the robot;
maintaining a mapping between emotion state values and respective sets of custom motion parameters, wherein the custom motion parameters control how procedural animations are performed by the robot;
receiving one or more animation parameters of a procedural animation to be performed by the robot;
obtaining a value of the current emotion state for the robot;
obtaining one or more custom motion parameters to which the current emotion state for the robot is mapped;
computing a custom motion trajectory from the one or more animation parameters of the procedural animation and the obtained one or more custom motion parameters to which the current emotion state for the robot is mapped; and
performing the procedural animation according to the computed custom motion trajectory.

17. The computer program product of claim 16, wherein the operations further comprise:
selecting, by the robot, a particular pregenerated animation based on a value for the current emotion state of the robot,
wherein the one or more custom motion parameters to which the current motion state for the robot is mapped match one or more characteristics of the particular pregenerated animation selected for the current emotion state of the robot.

18. The computer program product of claim 16, wherein the one or more custom motion parameters are task-specific parameters, and wherein computing the custom motion trajectory comprises computing the custom motion trajectory having one or more movement characteristics based on the task-specific parameters.

19. The computer program product of claim 16, wherein the one or more custom motion parameters comprise a duration parameter, and wherein computing the custom motion trajectory comprises computing the custom motion trajectory to have a duration matching the duration parameter.

20. A method performed by a robot, the method comprising:
maintaining a current emotion state for the robot, wherein the current emotion state is one value of a plurality of different emotion states, and wherein the robot is configured to select pregenerated animations based on a value of the current emotion state for the robot;
maintaining a mapping between emotion state values and respective sets of custom motion parameters, wherein the custom motion parameters control how procedural animations are performed by the robot;
receiving one or more animation parameters of a procedural animation to be performed by the robot;
obtaining a value of the current emotion state for the robot;
obtaining one or more custom motion parameters to which the current emotion state for the robot is mapped;
computing a custom motion trajectory from the one or more animation parameters of the procedural animation and the obtained one or more custom motion parameters to which the current emotion state for the robot is mapped; and
performing the procedural animation according to the computed custom motion trajectory.

21. An apparatus comprising:
one or more physically moveable components;
one or more processors; and
one or more storage devices storing instructions that are operable, when executed by the one or more processors, to cause the apparatus to perform operations comprising:
maintaining a current emotion state, wherein the current emotion state is one value of a plurality of different emotion states, and wherein the apparatus is configured to select pregenerated animations based on a value of the current emotion state for the apparatus;
maintaining a mapping between emotion state values and respective sets of custom motion parameters, wherein the custom motion parameters control how procedural animations are performed by the apparatus;
receiving one or more animation parameters of a procedural animation to be performed by the apparatus;
obtaining a value of the current emotion state for the apparatus;
obtaining one or more custom motion parameters to which the current emotion state for the apparatus is mapped;
computing a custom motion trajectory from the one or more animation parameters of the procedural animation and the obtained one or more custom motion parameters to which the current emotion state for the apparatus is mapped; and
performing the procedural animation according to the computed custom motion trajectory.
